(19) United States
(12) Patent Application Publication
(10) Pub. No.: US 2010/0023343 A1
(43) Pub. Date: Jan. 28, 2010

(54) Portable point of sale

(75) Inventors: Steven Roger Coleman, Richardson, TX (US); Mark Andrew Medlin, Wylie, TX (US)

Correspondence Address: DOCKET CLERK, P.O. DRAWER 800889, DALLAS, TX, 75380, US

(73) Assignee: Enfora, Inc., Richardson, TX (US)

(21) Appl. No.: 12/220,619

(22) Filed: Jul. 25, 2008

(51) Int. Cl. G06Q 30/00; G06Q 50/00

(52) U.S. Cl. 705/2; 705/26

(57) ABSTRACT

Systems and methods are disclosed that relate to providing information about an item available for sale. This item is selected for purchase by a buyer, and the location information of the buyer and seller are exchanged. As the buyer approaches the seller, the location of the seller is reported to the buyer. The sale can be completed upon the arrival of the buyer to the seller.

### TECHNICAL FIELD

Generally, the invention relates to computer networks and wireless devices, and, more particularly, marketing and sales using location information.

### BACKGROUND

Traditional point of sale (POS) transactions are conducted by a consumer going to a store, choosing an item, instructing a cashier as to the selected item, waiting for the item to be ready, paying for the item, and then leaving the store. There are many problems associated with this traditional POS transaction. First, communication difficulties may exist between the consumer and the cashier. Second, the ordering process creates necessary delays. Additionally, if a store has a long wait or an item is unavailable, a consumer will be unaware of the situation until after the consumer has exerted time, effort, and energy attempting to purchase an item.

### SUMMARY OF INVENTION

In one embodiment, a method is disclosed that relates to providing information about an item available for sale. This item is selected for purchase by a buyer, and the location information of the buyer and seller are exchanged. As the buyer approaches the seller, the location of the seller is reported to the buyer. The sale can be completed upon the arrival of the buyer to the seller.

In another embodiment, another method is disclosed that configures a user interface device to receive a plurality of alerts relating to item. This method also may include receiving an alert on the user interface device that the item is available for purchase. This alert may include sales information and the location of the item. This method may also include conducting a wireless transaction to purchase the item, notifying the seller of the item automatically when the buyer approaches to pick up the item, and completing the transaction.

In yet another embodiment, a system is disclosed that has a user interface that is capable of displaying information. In addition, the system also includes a memory component capable of storing information relating to the user interface and a plurality of user preferences. The system also has a location determining unit to determine the location of the system and to display the location of the system on the user interface. In addition, this system also has a wireless communication device that communicates with a second wireless communication device. The wireless communication device receives information relating to an item that corresponds to a preference in the memory component and displays the item on the user interface. The wireless communication promotes a transaction to purchase the item, and the wireless communication device provides the seller of the item location information relating to the buyer of the item.

### BRIEF DESCRIPTION OF THE DRAWINGS

For a more complete understanding of the present disclosure and the advantages thereof, reference is now made to the following brief description, taken in connection with the accompanying drawings and detailed description, wherein like reference numerals represent like parts.

FIG. 1 is a block diagram of one system of implementing a portable point of sale system.

FIG. 2 is a diagram illustrating a consumer within the range of an outer wireless service area.

FIG. 3 is a diagram illustrating a consumer within the range of an intermediate wireless service area.

FIG. 4 is a diagram illustrating a consumer within the range of a short-range wireless service area.

FIG. 5 is a diagram illustrating a preferences table.

FIG. 6 is a diagram of a consumer touch screen showing a main menu.

FIG. 7 is a diagram of a consumer touch screen showing a sub menu.

FIG. 8 is a diagram of a consumer touch screen showing a purchasing menu.

FIG. 9 is a flowchart of one embodiment of purchasing items using the portable point of sale system.

FIG. 10 illustrates an exemplary general purpose computer system suitable for implementing the several embodiments of the disclosure.

### DETAILED DESCRIPTION

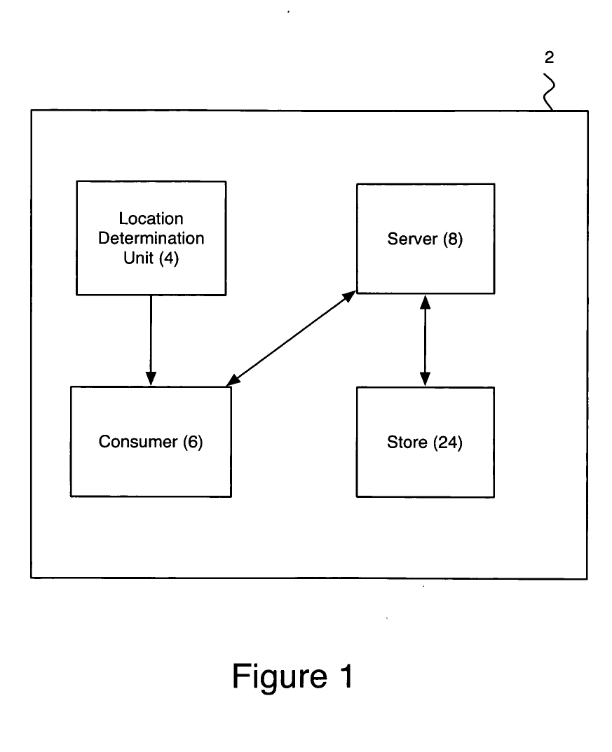

FIG. 1 is a block diagram of a portable point-of-sale (PPOS) system 2. The PPOS system 2 allows consumer 6 to exchange information with a server 8 and a location determination unit 4. Server 8 communicates with both consumer 6 and a store 24. In one embodiment, consumer 6 contacts location determination unit 4 and obtains location information relating to the position of consumer 6. Consumer 6 requests information relating to an item from server 8. Server 8 accepts this request and determines that the requested item is available at store 24. Server 8 then transmits information (e.g., price, description, etc.) relating to the requested item to consumer 6. Consumer 6 is then presented with information related to the item and the location of the item. Consumer 6 may then purchase the item from store 24 using server 8. Store 24 notified, through a method disclosed herein, when consumer 6 approaches store 24. PPOS system 2 allows two-way communication between store 24 and consumer 6. This communication allows store 24 to complete the transaction with consumer 6 without requiring that consumer 6 wait in line or place a traditional POS order.

Location determination unit 4 may be any device used to determine the location of consumer 6. Examples of location determination unit 4 include, but are not limited to, a global positioning system (GPS). It is understood that other methods of determining the location of consumer 6 may be used, including through the triangulation of signals transmitted to consumer 6 from cellular towers. It is understood that any method of determining the location of consumer 6 may be used consistent with the present disclosure.

The location determination unit 4 may be programmed to update the location of consumer 6 at any frequency. For instance, location determination unit 4 may be programmed to perform updates based upon the change in position of the consumer 6, the speed of consumer 6, or at a predetermined time interval.

Consumer 6 is an exemplary consumer with a communications interface device capable of communication with location determination unit 4 and server 8. For the purposes of this disclosure, consumer 6 may have an communications interface including, but not limited to, a mobile cell phone, a personal data assistant (PDA), a personal computer, a navigation system, or any other device capable of wireless communication. While no direct communication is shown between store 24 and consumer 6 it is understood that if consumer 6 is within the range of a network operated by store 24, consumer 6 may communicate directly with store 24.

Server 8 is a general-purpose computing device capable of communications with consumer 6 and store 24. Server 8 may be located at a wireless base station, at an Internet service provider (ISP), or any other location that allows consumer 6 to communicate with store 24.

Store 24 is an entity that communicates with server 8. Store 24 is able to accept orders from server 8 and consumer 6. Store 24 may be any kind of store, business, service, or other entity that may provide goods or services to consumer 6. Examples of goods that store 24 may sell include, but are not limited to, food, clothes, electronics or other consumer items. Examples of services that store 24 may provide include, but are not limited to, health, laundry, or other services. The use of the term “store” should not be construed as limiting, as store may be any entity that can communicate with either server 8 or consumer 6, and provide any service or good to consumer 6.

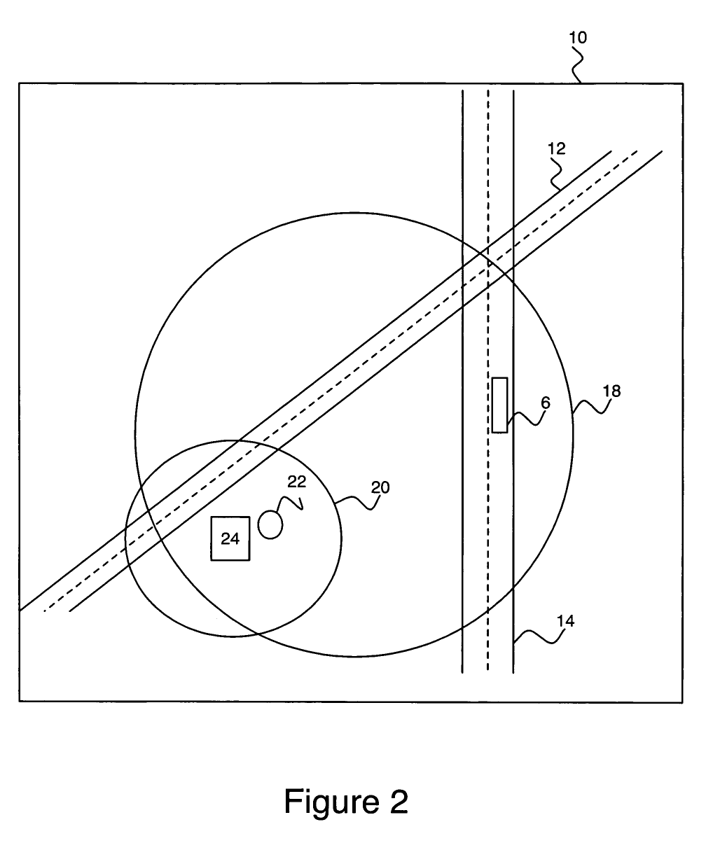

FIG. 2 is an illustration showing one embodiment of a portion of the PPOS system 2. In this embodiment, a map 10 shows consumer 6 on a first road 14. Also in this figure are a second road 12, a store 24, a large wireless range 18, a medium wireless range 20, and a small wireless range 22. FIG. 1 illustrates that consumer 6 is within large wireless range 18 but not within medium wireless range 20 or short wireless range 22. In the example shown in FIG. 2, medium wireless range 20 promotes direct communication between consumer 6 and store 24. However, consumer 6 is not within medium wireless range 20, so consumer 6 cannot communicate directly with store 24. In this embodiment, consumer 6 may use the large wireless range 18 to communicate with store 24 through server 8.

Large wireless range 18 may be any network capable of long-range communication, including, but not limited to cellular networks, satellite networks, and any other networks capable of long-range communication. An example of a large wireless range 18 networks include a wireless wide area network (WWAN). Examples of cellular networks include, but are not limited to, code division multiple access (CDMA) and global system for mobile communications (GSM) radio transceiver cards, and other well-known network standards.

Medium wireless range 20 may be any network capable of being operated by store 24. Examples of medium wireless range 20 networks include, but are not limited to, IEEE 802.11 standard and its successors (known today as 802.11 a, b, g, n, etc.; hereinafter, all of the 802.11 standards are referred to collectively as “802.11” unless explicitly stated otherwise). Medium wireless range 20 may, in some embodiments overlap portions of the large wireless range 18. In the event that consumer 6 travels into medium wireless range 20, it is understood that there may be a handoff between the wireless systems. In such a case, consumer 6 may use one or both of large wireless range 18 network or medium wireless range 20 network.

Short wireless range 22 is intended to refer to very short-range network communications. One example of this type of network is a short-range wireless protocol called Bluetooth. Bluetooth is implemented as a standardized protocol for short-range data communication using unlicensed radio frequencies. Another example of this short wireless range 22 is a radio-frequency (RFID) identification method. The short range allows for secure processing or payments, as well as the transmission of location information relating to consumer 6.

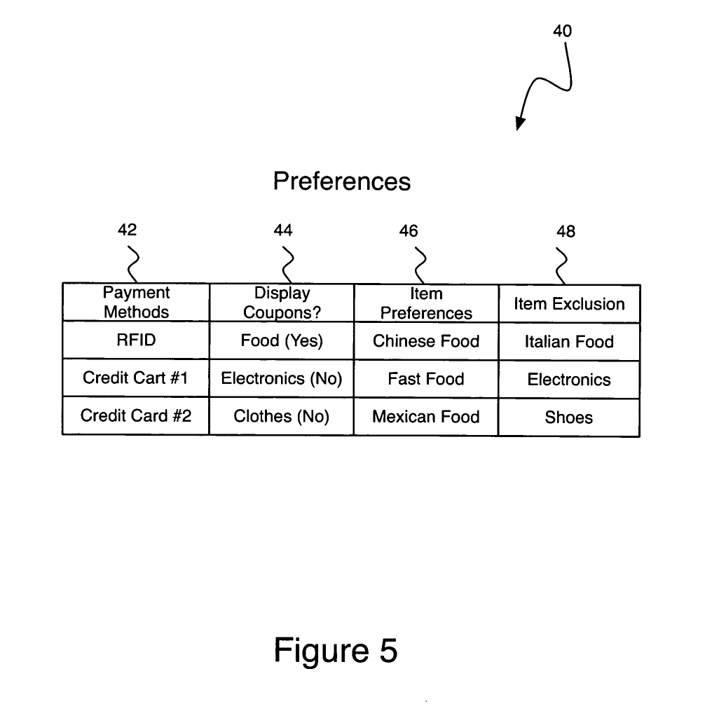

It is expressly understood that consumer 6 may configure the PPOS system 2 to alert consumer 6 when certain buying opportunities are near. As will be explained in FIG. 5, the user can set a plurality of preferences relating to items that consumer 6 is interested in. Consumer 6 may set PPOS system 2 to alert consumer 6 when a sale on a particular item is occurring. For instance, if consumer 6 is interested in buying shoes, and a sale is occurring within a predetermined range of the current location of consumer 6, an alert will appear on the communication interface device used by consumer 6. The alert may take the form of a text message, audio message, video message, or combination of forms. It is further understood that PPOS system 2 can act in an “active” mode (e.g. messages are pushed to the consumer interface device) and a passive mode (e.g. the consumer initiates a search for an item).

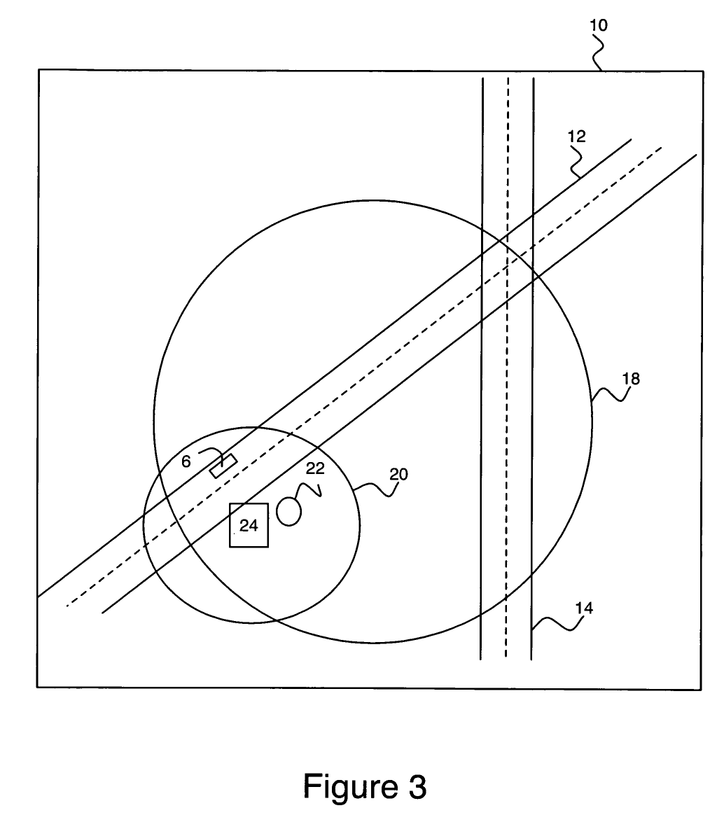

FIG. 3 is another map 10 that is substantially similar to FIG. 2. In this FIG. 3, consumer 6 is now within the range of medium wireless range 20. At this point, consumer 6 may communicate directly with store 24. This may allow for additional types of exchange of information. For instance, consumer 6 may alert store 24 that consumer 6 has arrived at store 24. In this way store 24 is aware of the presence of consumer 6, and can provide the requested goods or services to consumer 6. In addition, content that might unavailable in the large wireless range 18 network might be available in the medium wireless range 20. For instance, multimedia content that might be unavailable through large range wireless 18 network might be available in medium range wireless range 20. When consumer 6 comes within medium wireless range 20 an automated registration process might allow the consumer to complete transactions, or perform any other function with store 24.

One example where medium wireless range 20 may exchange large amounts of data is in the health services. Consumer 6 may register the presence of consumer 6 to a doctor in store 24 upon arriving at a medical office. In another embodiment, consumer 6 might require emergency medical attention and be taken to a hospital. At the hospital, consumer 6 might automatically transmit information relating to the medical emergency of consumer 6, information relating to the medical history of consumer 6, insurance information of consumer 6, and other information relating to consumer 6. In such a way, the hospital could have an integrated system allowing new or returning patents to avoid a lengthy checking process by providing all of the emergency medical information automatically.

While three ranges are shown, it is understood that any range of devices may be used consistent with this disclosure. The use of the three disclosed ranges is only for the purpose of illustrating alternative ranges. This disclosure should not be construed as to be limiting as to any particular range or number of ranges.

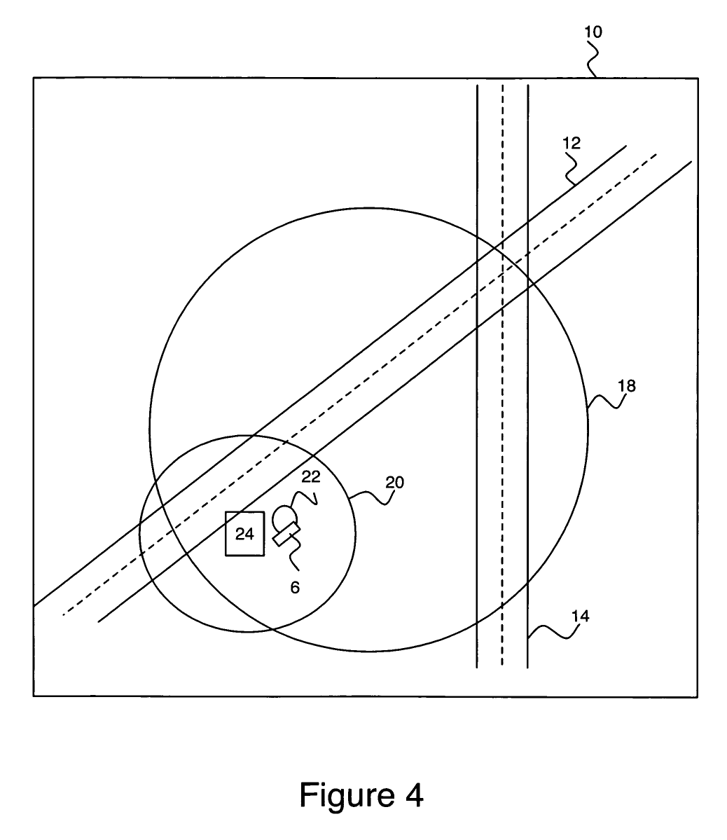

FIG. 4 is also substantially similar to FIG. 2. In this illustration, consumer 6 has arrived at store 24 and is within the range of short wireless range 22. At this range, the transition between consumer 6 and store 24 may be completed using Bluetooth, RFID, or any other short-range technology. In addition, the short wireless range 22 allows store 24 to become aware of the location of consumer 6. The ability for store 24 to be aware of the location of consumer 6 allows for several innovative features. For example, if in-store 24 was a service-oriented business, such the dry cleaner, the dry cleaner might bring the clothes to consumer 6 upon the arrival of consumer 6.

FIG. 5 shows a table 40 showing the preferences of consumer 6. This table may be stored locally within a machine owned and used by consumer 6 or may be stored on a server 8. It is closely understood that the preferences shown here are for exemplary purposes only and other preferences may be present within the disclosed system. There are four columns for preferences shown in table 40, payment methods 42, display coupons 44, item preferences 46, and item exclusion 48. These columns are used for illustrative purposes only, and are offered to show the available options of consumer 6.

Payment methods 42 may be used to determine what type payments the consumer prefers to use. If consumer 6 prefers to use RFID, RFID will be noted in the payment method column. Consumer 6 may also store one or more credit cards within the payment methods. Consumer 6 may select from these payment methods at time of purchase to automate the purchase products process. In this way, when consumer 6 selects an item to be purchased from store 24, the order can be transmitted to store 24, the order acknowledged by store 24, and the item paid for all seamlessly without requiring the physical presence of consumer 6.

Column 44 allows consumer 6 to determine what coupons or promotions to accept from different categories of vendors. For instance, if consumer 6 prefers to receive coupons for food but does not want to receive coupons for electronics or clothes, consumer 6 will only be shown coupons for food. It is understood that any criteria or classification may be used to determine what types of information the consumer wants to receive (e.g. rather than coupons, promotional or other material may be offered).

Item preferences 46 allow the consumer to list one or more types of goods or services that the consumer is interested in purchasing. In the present example, consumer 6 indicated a preference for Chinese, fast, and Mexican food. Therefore, in some embodiments, whenever consumer 6 is looking for restaurants, restaurants that correspond to item preferences 46 will first be presented to consumer 6.

Item exclusion 48 is a list of items to which consumer 6 is not interested in. In the example embodiment given in FIG. 5 consumer 6 has excluded Italian food, electronics, and shoes. Consumer 6 does not wish to receive information relating to these stores. This is useful if, for instance, consumer 6 requested information relating to restaurants in the area. Consumer 6 would not be shown any Italian restaurants based on the consumers preferences.

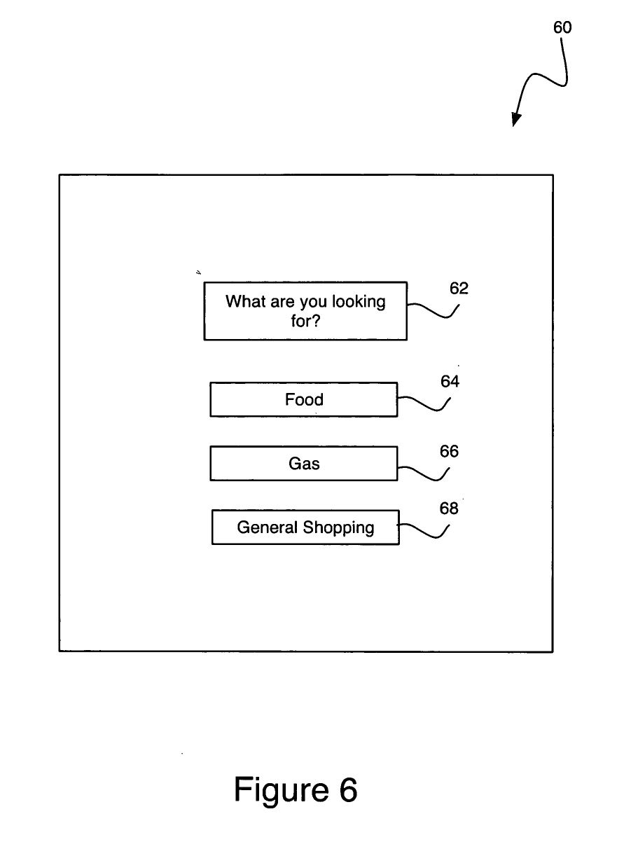

FIG. 6 is a screenshot 60 of a main menu that may be displayed on any mobile device used by consumer 6. Examples of mobile devices include but are not limited to screens mounted within a vehicle, GPS and devices, mobile phones, general-purpose computer or any other device capable of communication with store 24 or server 8. Consumer 6 is presented with a main option 62 that asks what the consumer is looking for. Consumer 6 is presented with three options under the main option: food 64, gas 66, and general shopping 68. It is understood that any number of different options may be presented to consumer 6. Depending upon the option that consumer 6 selects, the PPOS system 2 will attempt to find options that correspond to that category of choice.

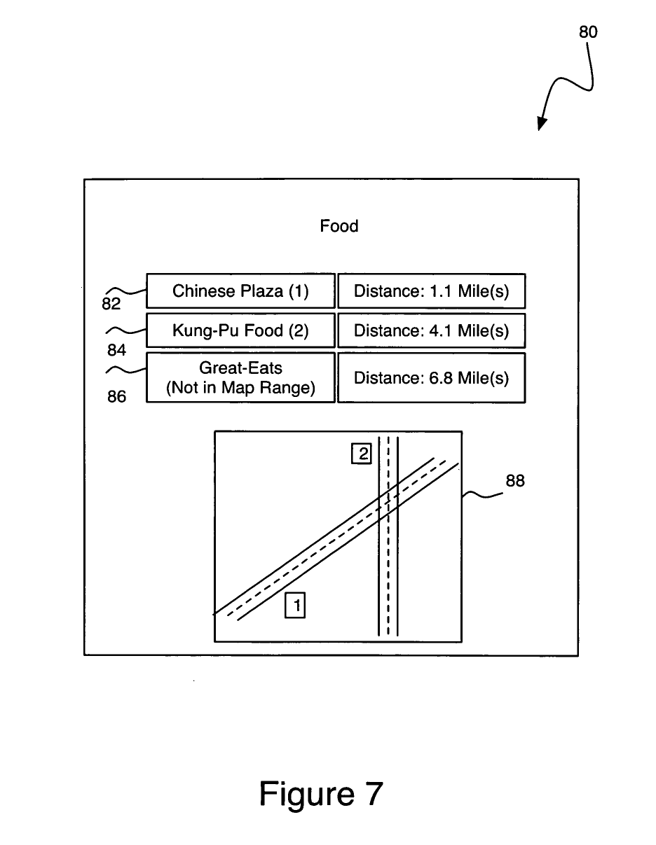

FIG. 7 is an example of a screenshot that might appear after the screenshot of FIG. 6 if the consumer selects food 64. A first choice 82, a second choice 84, and a third choice 86 are shown with the relative distance from consumer 6. The location of consumer 6 is determined through the use of one of the aforementioned methods of triangulation or GPS navigation. A map 88 is displayed below the options, which shows the locations of the choices presented.

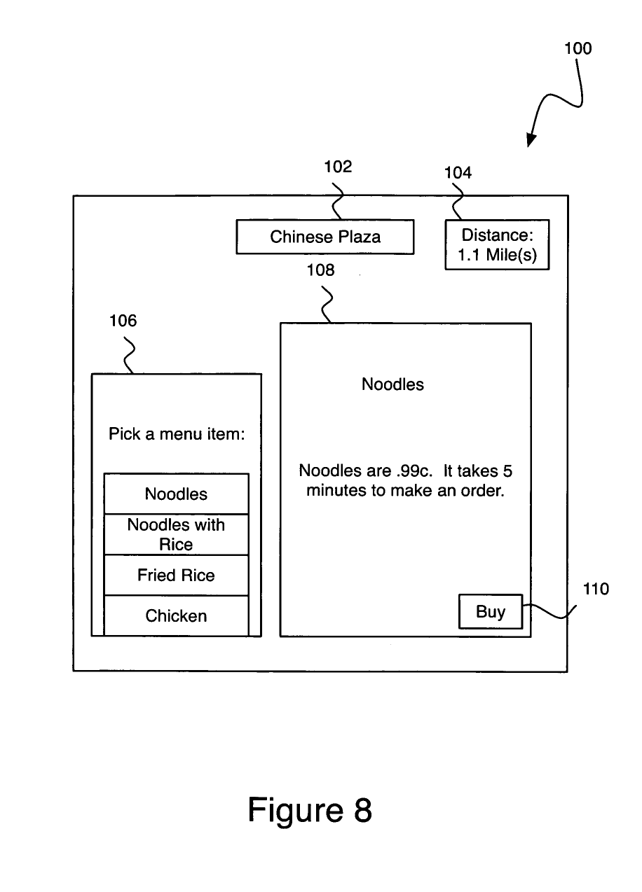

FIG. 8 is a screenshot of the possible options presented to consumer 6, if consumer 6 selects the first option 82. In this example, the title of the name of the restaurant consumer 6 has chosen is shown in block 102. The distance of the option from consumer 6 is shown in block 104. Consumer 6 is presented with a menu that lists the items available at restaurant 102. In the example embodiment shown in FIG. 8, consumer 6 selects noodles as shown in block 108. Consumer 6 can purchase noodles 108 using select button 110. In such a case, PPOS system 2 will transmit information relating to be purchased to store 102.

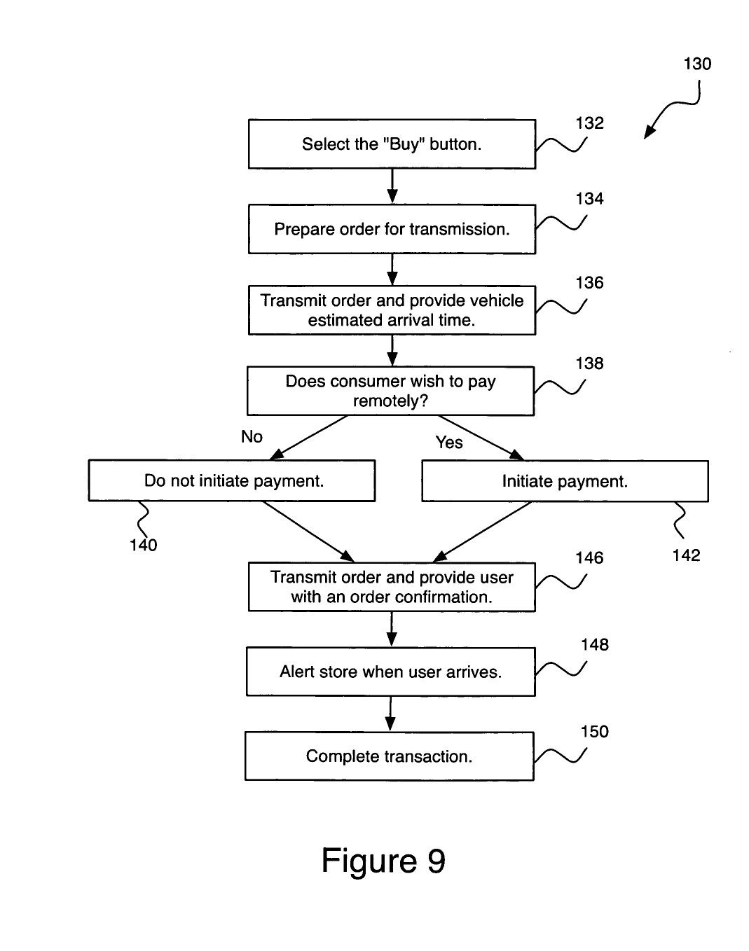

FIG. 9 is an example flowchart 130 of one method of implementing the presently disclosed systems and methods. In block 132, consumer 6 first selects the buy button 110. In block 134 the system prepares the order for transmission. This preparation may include determining what information the consumer wishes to transmit concurrently with the order. Examples of information that consumer 6 may choose to transmit include, but are not limited to, specific instructions, vehicle description, or vehicle location.

In block 136, consumer 6 transmits order information and provides the vehicle's estimated time of arrival or the distance the vehicle is from store 24. In block 138, the PPOS system 2 will check the consumer preferences to determine whether the consumer wishes to pay remotely. If the consumer does not wish to pay remotely there will be no payment initiated as shown in block 140. If the consumer does wish to cement a payment, a remote payment will be initiated as shown in block 142. In block 146, consumer 6 receives an order confirmation. In block 148 the consumer drives to store 24 and store 24 is alerted to the presence of consumer 6. In block 150, the transaction is completed and consumer 6 completes the purchase from store 24.

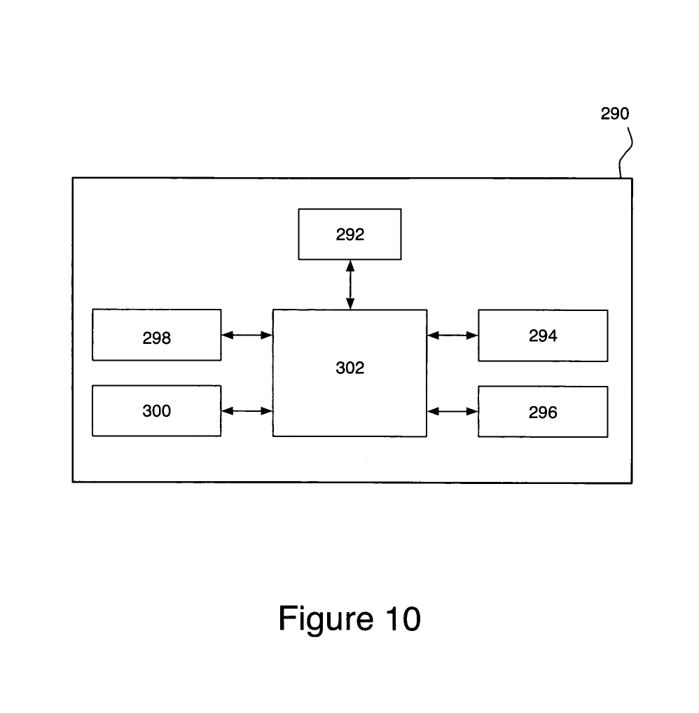

Server 8 described above may be implemented on any general-purpose computer 290 with sufficient processing power, memory resources, and network throughput capability to handle the necessary workload placed upon it. A consumer home personal computer, networked to a central server 8 through a wide area network, such as the Internet, may be used in conjunction with the disclosed embodiments. The consumer home personal computer may share some, or all, of the elements of server 8. FIG. 10 illustrates a typical, general-purpose computer system suitable for implementing one or more embodiments disclosed herein. The general-purpose computer 290 includes a processor 302 (which may be referred to as a central processor unit or CPU) that is in communication with memory devices including secondary storage 292, read only memory (ROM) 294, random access memory (RAM) 296, input/output (I/O) 298 devices, and network connectivity devices 300. The processor may be implemented as one or more CPU chips.

The secondary storage 292 is typically comprised of one or more disk drives or tape drives and is used for non-volatile storage of data and as an over-flow data storage device if RAM 296 is not large enough to hold all working data. Secondary storage 292 may be used to store programs that are loaded into RAM 296 when such programs are selected for execution. The ROM 294 is used to store instructions and perhaps data that are read during program execution. ROM 294 is a non-volatile memory device that typically has a small memory capacity relative to the larger memory capacity of secondary storage. The RAM 296 is used to store volatile data and perhaps to store instructions. Access to both ROM 294 and RAM 296 is typically faster than to secondary storage 292.

I/O 298 devices may include printers, video monitors, liquid crystal displays (LCDs), touch screen displays, keyboards, keypads, switches, dials, mice, track balls, voice recognizers, card readers, paper tape readers, or other well-known input devices. The network connectivity devices 392 may take the form of modems, modem banks, ethernet cards, universal serial bus (USB) interface cards, serial interfaces, token ring cards, fiber distributed data interface (FDDI) cards, wireless local area network (WLAN) cards, radio transceiver cards such as code division multiple access (CDMA) and/or global system for mobile communications (GSM) radio transceiver cards, and other well-known network devices. These network connectivity devices 300 may enable the processor 302 to communicate with an Internet or one or more intranets. With such a network connection, it is contemplated that the processor 302 might receive information from the network, or might output information to the network in the course of performing the above-described method steps.

Such information, which may include data or instructions to be executed using processor 302 for example, may be received from and outputted to the network, for example, in the form of a computer data baseband signal or signal embodied in a carrier wave. The baseband signal or signal embodied in the carrier wave generated by the network connectivity devices 300 may propagate in or on the surface of electrical conductors, in coaxial cables, in waveguides, in optical media, for example optical fiber, or in the air or free space.

The information contained in the baseband signal or signal embedded in the carrier wave may be ordered according to different sequences, as may be desirable for either processing or generating the information or transmitting or receiving the information. The baseband signal or signal embedded in the carrier wave, or other types of signals currently used or hereafter developed, referred to herein as the transmission medium, may be generated according to several methods well known to one skilled in the art.

The processor 302 executes instructions, codes, computer programs, scripts that it accesses from hard disk, floppy disk, optical disk (these various disk based systems may all be considered secondary storage 292), ROM 294, RAM 296, or the network connectivity devices 300.

While several embodiments have been provided in the present disclosure, it should be understood that the disclosed systems and methods might be embodied in many other specific forms without departing from the spirit or scope of the present disclosure. The present examples are to be considered as illustrative and not restrictive, and the intention is not to be limited to the details given herein. For example, the various elements or components may be combined or integrated in another system or certain features may be omitted, or not implemented.

Also, techniques, systems, subsystems and methods described and illustrated in the various embodiments as discrete or separate may be combined or integrated with other systems, modules, techniques, or methods without departing from the scope of the present disclosure. Other products shown or discussed as directly coupled or communicating with each other may be coupled through some interface or device, such that the products may no longer be considered directly coupled to each other but may still be indirectly coupled and in communication, whether electrically, mechanically, or otherwise with one another. Other examples of changes, substitutions, and alterations are ascertainable by one skilled in the art and could be made without departing from the spirit and scope disclosed herein.

It should be understood that although an exemplary implementation of one embodiment of the present disclosure is illustrated above, the present system may be implemented using any number of techniques, whether currently known or in existence. The present disclosure should in no way be limited to the exemplary implementations, drawings, and techniques illustrated above, including the exemplary design and implementation illustrated and described herein, but may be modified within the scope of the appended claims along with their full scope of equivalents.

We claim:

1. A method, comprising:
providing information relating to an item available for sale by a seller to a buyer;
accepting a selection for an item to purchase by the buyer through a transaction;
exchanging location information of both the buyer and a seller;
updating the seller automatically through a wireless network of the change in distance of the buyer from the seller; and
completing the sale of the item.

2. The method of claim 1, wherein the item is a service.

3. The method of claim 1, wherein the item is a good.

4. The method of claim 1, wherein the buyer is a consumer with a portable electronics device.

5. The method of claim 4, wherein the portable electronics device is selected from a group of navigation system, personal computer, or personal digital assistant.

6. The method of claim 2, wherein the service is a health care provider.

7. A method, comprising:
configuring a user interface device, wherein the user interface device is configured to receive a plurality of alerts relating to item;
receiving an alert on the user interface device, wherein the alert indicates that the item is available for purchase, and wherein the alert comprises sales information and the location of the item;
conducting a wireless transaction to purchase the item;
notifying the seller of the item automatically when the buyer approaches to pick up the item; and
completing the transaction.

8. The method of claim 7, wherein the user interface device is a personal data assistant.

9. The method of claim 7, further comprising providing the user with location information relating to the item to be purchased.

10. The method of claim 7, wherein the alert comprises a text message.

11. The method of claim 7, wherein the alert is configured to appear when the user interface device is within a predetermined range.

12. The method of claim 7, further comprising determining the location of the user interface device.

13. The method of claim 12, wherein the location of the user interface device is determined through a global positioning system.

14. A system, comprising:
a user interface, wherein the user interface comprises an output device capable of displaying information;
a memory component, wherein the memory component is capable of storing information relating to the user interface and a plurality of user preferences;
a location determining unit, wherein the location determining unit is able to determine the location of the system, and wherein the location determining unit displays the location of the system on the user interface; and
a wireless communication device, wherein the wireless communication device is capable of communicating with a second wireless communication device, wherein the wireless communication device receives information relating to a item that corresponds to a preference in the memory component, wherein the information relating to the item is displayed on the user interface, wherein the wireless communication promotes a transaction to purchase the item, and wherein the wireless communication device provides the seller of the item location information relating to the buyer of the item.

15. The system of claim 14, wherein the first and second wireless communication devices use a cellular network.

16. The system of claim 14, further comprising the wireless communication device determining the distance between the system and the item.

17. The system of claim 14, wherein the user interfaces comprises a touch screen.

18. The system of claim 14, wherein the user preferences are created on a second system and transferred to the system.

19. The system of claim 14, wherein the item is a service.

20. The method of claim 14, wherein the plurality of user preferences comprise consumer preferences and exclusions.
